(19) United States
(12) Patent Application Publication
(10) Pub. No.: US 2011/0014867 A1
(43) Pub. Date: Jan. 20, 2011

(54) WIRELESS ELECTRONIC DEVICE REMOTE CONTROLLER

(76) Inventor: Wan-Tien CHEN, Taipei (TW)

Correspondence Address: Guice Patents PLLC, 12647 Galveston Court #302, Manassas, VA, 20112, US

(21) Appl. No.: 12/555,893

(22) Filed: Sep. 9, 2009

(30) Foreign Application Priority Data
Jul. 16, 2009 (TW) 098212969

(51) Int. Cl. H04B 7/00; H04M 1/00

(52) U.S. Cl. 455/41.2; 455/556.1

(57) ABSTRACT

The present invention relates to a wireless electronic device remote controller, comprises: a hand-held wireless communication device in which at least one display device, a first wireless communication module and a second wireless communication module are installed, wherein the first wireless communication modules is able to be connected to a base station for a communication purpose; and a power adapter having communication function, coupled to an electronic device, the power adapter having communication function at least includes a third wireless communication module that receives commands from the second wireless communication module to determine whether supply power to the electronic device.

### BACKGROUND OF THE INVENTION

1. Field of the Invention

The present invention relates to a wireless electronic device remote controller, more particularly to a wireless electronic device remote controller in which a Zigbee, Blue-tooth or RF wireless communication module is build in both a mobile phone and a power adapter, so a user can remotely control the power of electronic device through the Zigbee, Blue-tooth or RF wireless communication module so each electronic device is equipped with functions of being operated with certain time and magnitude and environmental benefit of power saving and carbon reducing is achieved.

2. Description of Related Art

A remote controller of conventional electronic device generally utilizes infrared or UHF as a remote controlling means. The Taiwan Patent No. M359878, titled “Remote control system”, has disclosed a remote control system that is used to control at least one electronic device, the remote control system includes: a remote controller for emitting an infrared controlling signal; a wireless integrating controlling device for receiving the infrared controlling signal and transferring the infrared controlling signal to a RF signal and emitting the RF signal; wherein the at least one electronic device receives the RF signal emitted by the wireless integrating controlling device and is operated according to the RF signal. Infrared has disadvantages of short emitting distance and easy to be blocked, infrared is therefore not suitable for a long distance remote control.

The Taiwan Patent No. M350185, titled “Remote wireless control device”, has disclosed a remote wireless control device that comprises a main control unit, the main control unit consists of a Micro Control Unit (MCU) connecting to at least one circuit device, e.g. a network, public phone, GSM or USB communication device, a decoding and code-sending IC, an output controller, a trigger signal switch and a wireless transceiver (UHF RF transceiver) able to be connected to the network, public phone, GSM or USB communication device; at least one controlled unit, the controlled unit consists of a wireless transceiver (UHF RF transceiver), a decoding and code-sending IC, and an output controller able to be connected to information domestic electronic device; wherein the main control unit further includes a display device and also able to be equipped with a setting device that enables a user to browse or set; furthermore, the main control unit is able to be remotely controlled by a hand-held remote controller. The structure of the disclosed art is complicated and can not enable a mobile phone to directly control the domestic electronic device.

The Taiwan Patent No. I312241, titled “Remote controller having calling function” has disclosed a remote controller that comprises an input module having an input panel, a touch panel controlling device for generating coordinate data with respect to the input panel, and a hand-writing and track-identifying controller for determining the coordinate data from the touch panel controlling device to generate codes or text codes of human-machine interaction. The remote controller further comprises a data transferring interface for transferring data to an electronic device, a microphone for converting a sound wave to a sound signal, a speaker for converting the sound signal to the sound wave, an image capturing module for converting an image into an image signal, an image displaying module for converting the image signal to the image, and a control unit for controlling the data transferring interface to transfer data to the electronic device. The disclosed remote controller has a calling function for enabling dialing or answering a network phone call or dialing to a conventional phone through a public phone network, but the disclosed remote controller is not a general mobile phone, so when a user goes out of his place, he not only has to carry a mobile phone but also the remote controller; this will cause additional expenditure to the user and not easy to carry around.

As for a so-called intelligent domestic electronics control system, during the house decorating/renovating period, all electronic devices and mobile furniture to be controlled have to be processed with an internal wiring operation, and signal wires thereof have to be connected to a main control system, e.g. a PC, then all operations are controlled by the main control system. For accommodating said system, a space has to be spared to install the control chamber of the main control system; thus the whole cost is relatively high and not affordable for ordinary residence.

### SUMMARY OF THE INVENTION

One object of the present invention is to provide a wires electronic device remote controller in which a Zigbee, Blue-tooth or RF wireless communication module is build in both a mobile phone and a power adapter of electronic device, so a user can remotely control the power of electronic device through the mobile phone.

Another object of the present invention is to provide a wires electronic device remote controller in which a Zigbee, Blue-tooth or RF wireless communication module is build in both a mobile phone and a distribution box, so a user can remotely control the power of electronic device through the mobile phone.

One another object of the present invention is to provide a wires electronic device remote controller that so each electronic device is equipped with functions of being operated with certain time and magnitude and environmental benefit of power saving and carbon reducing is achieved.

For achieving the above mentioned objects, one solution provided by the present invention is to provide a wireless electronic device remote controller, comprises: a hand-held wireless communication device in which at least one display device, a first wireless communication module and a second wireless communication module are installed, wherein the first wireless communication modules is able to be connected to a base station for a communication purpose; and a power adapter having communication function, coupled to an electronic device, the power adapter having communication function at least includes a third wireless communication module that receives commands from the second wireless communication module to determine whether supply power to the electronic device.

For achieving the above mentioned objects, another solution provided by the present invention is to provide a wireless electronic device remote controller, comprises: a hand-held wireless communication device in which at least one display device, a first wireless communication module and a second wireless communication module are installed, wherein the first wireless communication modules is able to be connected to a base station for a communication purpose; and a distribution box having communication function having at least one breaker and at least a third wireless communication module, one end of the breaker is coupled to a AC power and the other end thereof is coupled to at least one electronic device, the third wireless communication module receives commands from the second wireless communication module to control the breaker whether supplies power to the electronic device.

### BRIEF DESCRIPTION OF THE DRAWINGS

FIG. 1 is a schematic view illustrating the operation of the wireless electronic device remote controller of one preferred embodiment of the present invention;

FIG. 2 is a schematic block diagram illustrating the wireless electronic device remote controller of one preferred embodiment of the present invention controlling the power of a DC electronic device;

FIG. 3 is a schematic block diagram illustrating the wireless electronic device remote controller of one preferred embodiment of the present invention controlling the power of an AC electronic device;

FIG. 4 is a schematic view illustrating the operation of the wireless electronic device remote controller of another preferred embodiment of the present invention;

FIG. 5 is a schematic block diagram illustrating the wireless electronic device remote controller of another preferred embodiment of the present invention controlling the power of a DC electronic device;

FIG. 6 is a schematic block diagram illustrating the wireless electronic device remote controller of another preferred embodiment of the present invention controlling the power of an AC electronic device.

### DETAILED DESCRIPTION OF THE PREFERRED EMBODIMENT

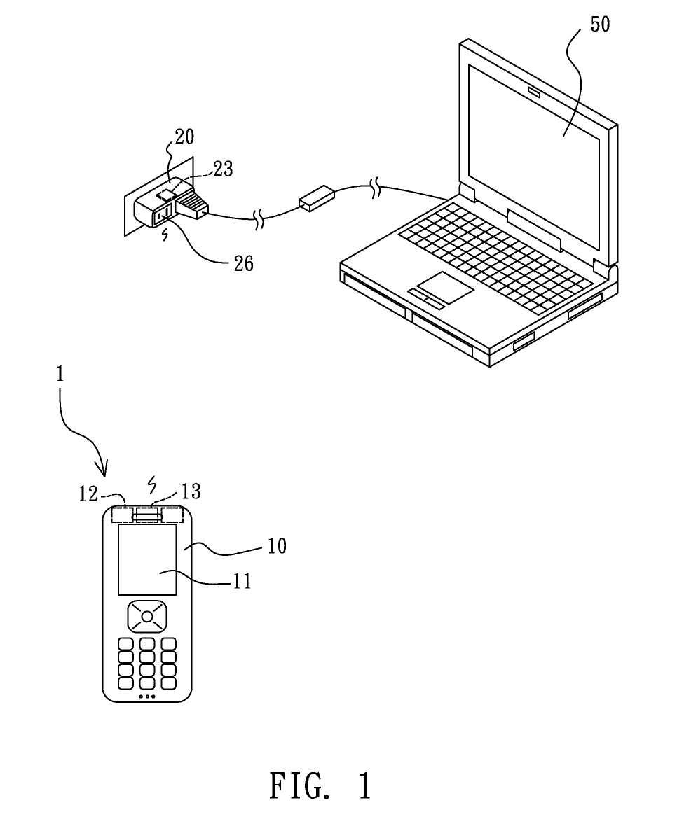

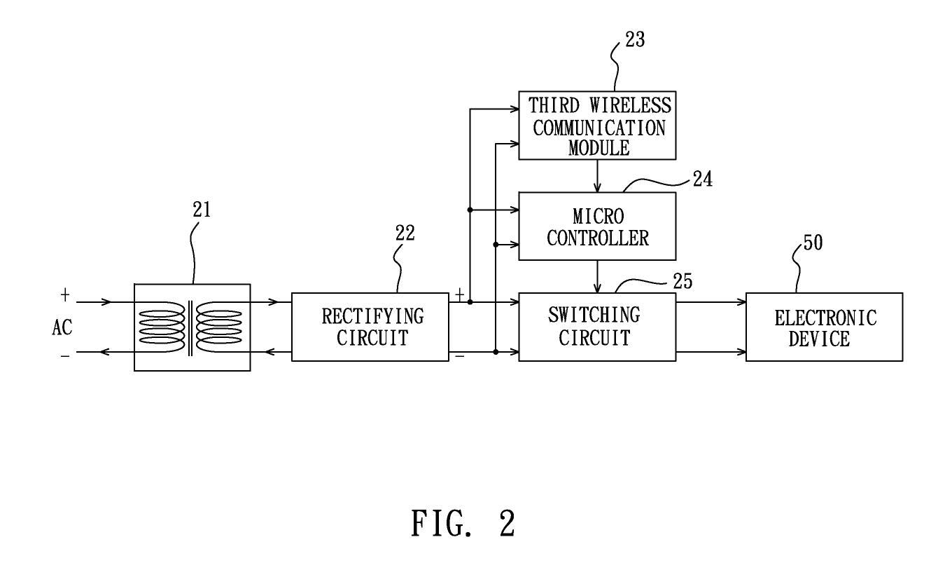

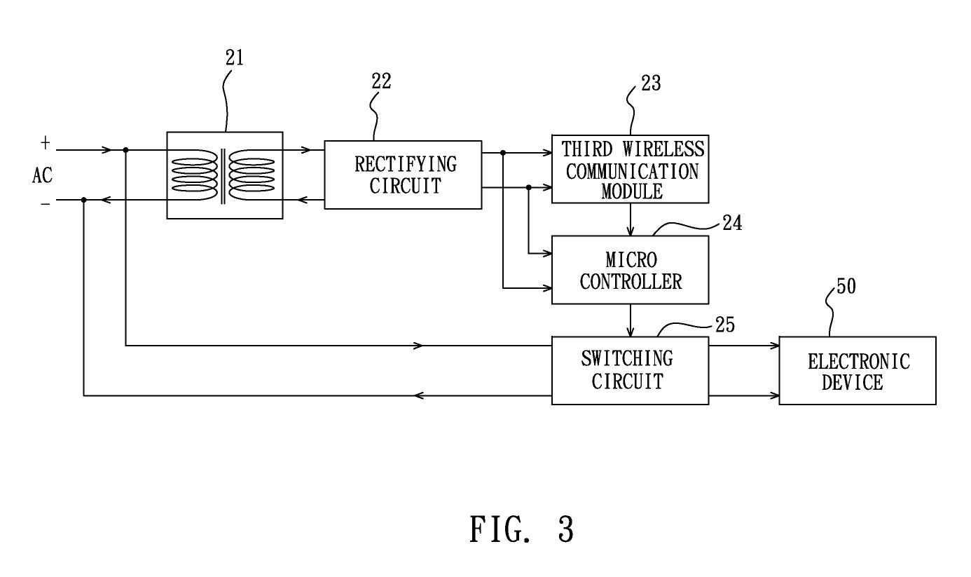

Referring from FIG. 1 to FIG. 3, wherein FIG. 1 is a schematic view illustrating the operation of the wireless electronic device remote controller of one preferred embodiment of the present invention; FIG. 2 is a schematic block diagram illustrating the wireless electronic device remote controller of one preferred embodiment of the present invention controlling the power of a DC electronic device; FIG. 3 is a schematic block diagram illustrating the wireless electronic device remote controller of one preferred embodiment of the present invention controlling the power of an AC electronic device.

As shown in figures, the wireless electronic device remote controller 1 provided by the present invention comprises: a hand-held wireless communication device 10; and at least one power adaptor 20 having communication function.

The hand-held wireless communication device 10 is, e.g. but not limited to, a mobile phone, at least one display device 11, a first wireless communication module 12 and a second wireless communication module 13 are installed within, wherein the display device 11 is, e.g. but not limited to, a LCD display device, the first wireless communication module 12 is, e.g. but not limited to, a GSM, CDMA, W-CDMA, CDMA2000 or CMMB wireless communication module that is able to be connected to a base station (not shown) for a communication purpose. The display device 11 and the first wireless communication module 12 are conventional devices therefore will not be further illustrated. The second wireless communication module 13 is, e.g. but not limited to, a Zigbee communication module, a Blue-tooth communication module or a RF communication module; in this embodiment the Zigbee communication module is adopted for illustration but not served as a limitation; the software and hardware of the Zigbee communication module are in compliance with IEEE802.15.4 and the Zigbee Alliance, wherein the physical layer (PHY), the media access control layer (MAC) and the data link layer (Data Link) are in compliance with IEEE, and the Zigbee Alliance are accountable for setting logical network, data transferring encoding mechanism, application interface regulation and inter-communication regulation among system components, the topology can be stellate (one to more), point to point (one to one), or tree-like means, details are referred to the manual of Zigbee.

The power adaptor 20 having communication function is coupled to an electronic device 50, e.g. but not limited to, a computer, an air conditioner, a television or a lamp. The power adaptor 20 having communication function receives commands from the second wireless communication module 13 and determines whether supply power to the electronic device 50.

As shown in FIG. 2, when the electronic device 50 is an electronic device directly utilizing DC power, e.g. a notebook computer or a digital camera, the power adaptor 20 having communication function are further installed with: a transformer 21, a rectifying circuit 22, a third wireless communication module 23, a micro controller 24, a switching circuit 25, and at least one socket 26.

One primary side of the transformer 21 is coupled to the AC power, e.g. but not limited to, AC110V or AC220V, and performs a voltage lowering operation to the AC power.

The rectifying circuit 22 is, e.g. but not limited to, a full-wave bridge rectifying circuit, that is coupled to a secondary side of the transformer 21, and is served to rectify the AC power after being operated with the voltage lowering operation to the desired DC power, e.g. but not limited to, DC5V.

The third wireless communication module 23 is, e.g. but not limited to, a Zigbee communication module, one end thereof is coupled to the rectifying circuit 22 to obtain the required power, the other end thereof is coupled to the micro controller 24; the third wireless communication module 23 receives commands from the second wireless communication module 13 and the commands are decoded then output to the micro controller 24.

The micro controller 24 is coupled to the rectifying circuit 22 and the third wireless communication module 23, and operates relative controls, e.g. but not limited to control the ON or OFF status of the switching circuit 25, according to commands of the third wireless communication module 23.

The switching circuit 25 is, e.g. but not limited to, a relay, one end thereof is coupled to the DC power and the other end thereof is coupled to the micro controller 24, the switching circuit 25 receives controls from the micro controller 24 so as to be opened or closed, so the DC power is controlled whether output to the electronic device 50.

The at least one socket 26 is coupled to the switching circuit 25 so the electronic device 50 can be plugged therein. In this embodiment two sockets 26 are adopted for illustration but not served as a limitation.

With the wireless electronic device remote controller provided by the present invention, when a user is several hundred meters away from home, the second wireless communication module 13 of the hand-held wireless communication device 10 can be served to turn on or shut off the power of domestic electronic device 50, therefore each electronic device is equipped with functions of being operated with certain time and magnitude, and environmental benefit of power saving and carbon reducing is achieved. So the wireless electronic device remote controller provided by the present invention is novel compared to a conventional domestic electronic device control system.

As shown in FIG. 3, when the electronic device 50 is an electronic device directly utilizing AC power, e.g. an air conditioner, a television or a lamp, one side of the switching circuit 25 of the present invention is directly coupled to the AC power, the other side thereof is coupled to the micro controller 24, the switching circuit 25 receives controls from the micro controller 24 so as to be controlled whether output the AC power to the electronic device 50.

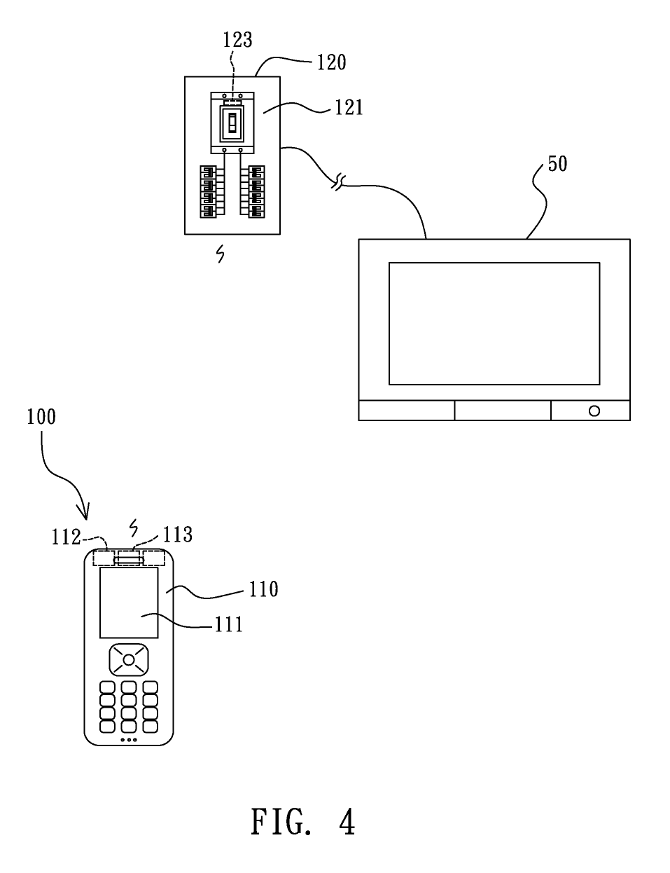

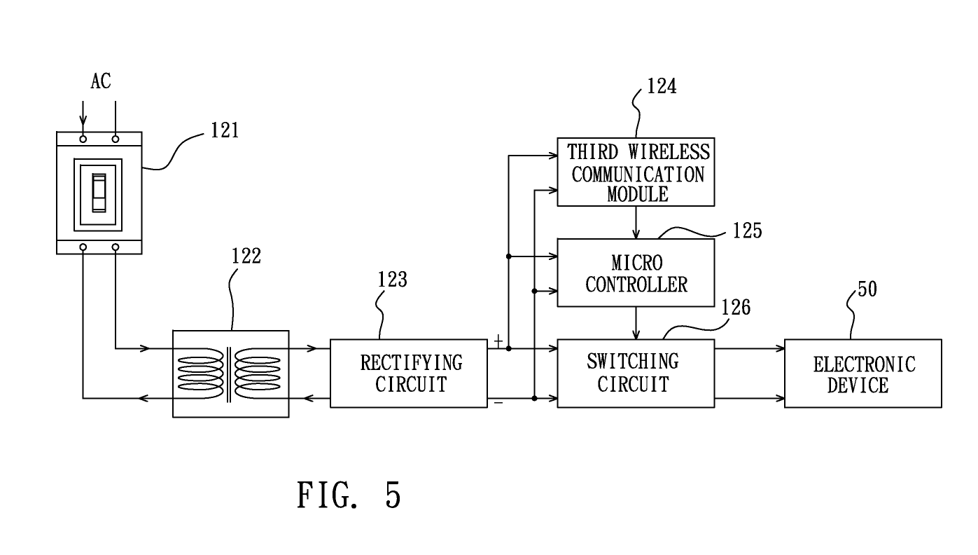

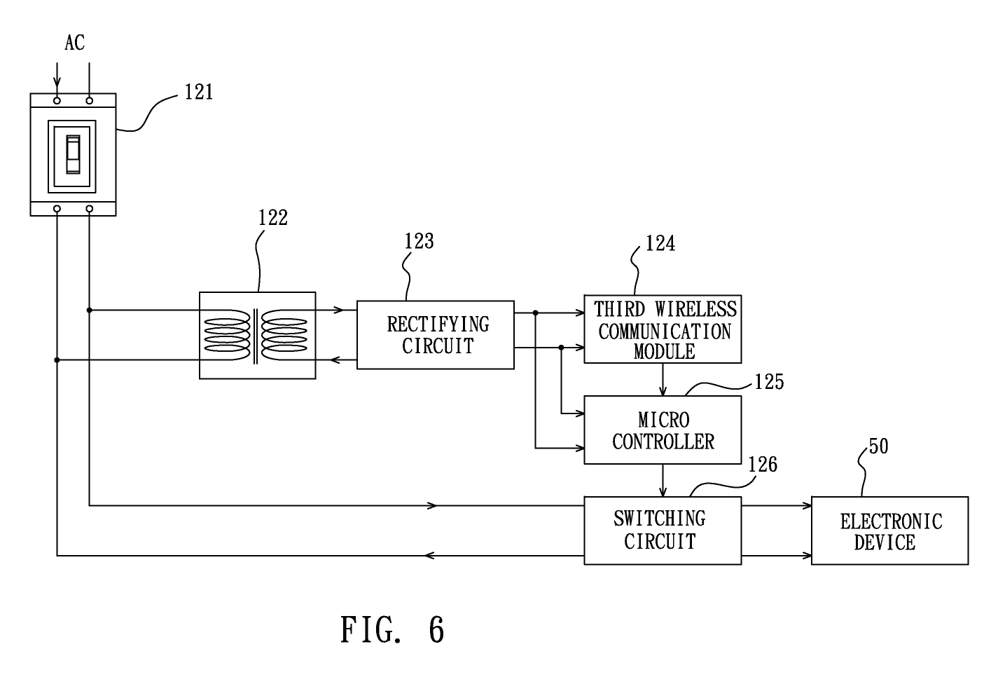

Referring from FIG. 4 to FIG. 6, wherein FIG. 4 is a schematic view illustrating the operation of the wireless electronic device remote controller of another preferred embodiment of the present invention; FIG. 5 is a schematic block diagram illustrating the wireless electronic device remote controller of another preferred embodiment of the present invention controlling the power of a DC electronic device; FIG. 6 is a schematic block diagram illustrating the wireless electronic device remote controller of another preferred embodiment of the present invention controlling the power of an AC electronic device.

As shown in FIG. 4, the wireless electronic device remote controller 100 provided by the present invention comprises: a hand-held wireless communication device 110; and a distribution box 120 having communication function.

The hand-held wireless communication device 110 is, e.g. but not limited to, a mobile phone, at least one display device 111, a first wireless communication module 112 and a second wireless communication module 113 are installed within, wherein the display device 111 is, e.g. but not limited to, a LCD display device, the first wireless communication module 112 is, e.g. but not limited to, a GSM, CDMA, W-CDMA, CDMA2000 or CMMB wireless communication module that is able to be connected to a base station (not shown) for a communication purpose. The display device 111 and the first wireless communication module 112 are conventional devices therefore will not be further illustrated. The second wireless communication module 113 is, e.g. but not limited to, a Zigbee communication module, a Blue-tooth communication module or a RF communication module; in this embodiment the Zigbee communication module is adopted for illustration but not served as a limitation.

The distribution box 120 having communication function is coupled to at least one electronic device 50, e.g. but not limited to, a computer, an air conditioner, a television or a lamp, the distribution box 120 having communication function receives commands from the second wireless communication module 113 to determine whether supply power to the electronic device 50.

As shown in FIG. 5, when the electronic device 50 is an electronic device directly utilizing DC power, e.g. a notebook computer or a digital camera, the distribution box 120 having communication function includes at least one breaker 121, a transformer 122, a rectifying circuit 123, a third wireless communication module 124, a micro controller 125, and a switching circuit 126.

One end of the breaker 121 is coupled to an AC power, the other end thereof is coupled to a primary side of the transformer 122.

One primary side of the transformer 122 is coupled to the output end of the breaker 121 to perform a voltage lowering operation to the AC power, e.g. but not limited to AC110V or AC220V.

The rectifying circuit 123 is, e.g. but not limited to, a full-wave bridge rectifying circuit, that is coupled to a secondary side of the transformer 122, and is served to rectify the AC power after being operated with the voltage lowering operation to the desired DC power, e.g. but not limited to DC5V.

The third wireless communication module 124 is, e.g. but not limited to, a Zigbee communication module, one end thereof is coupled to the rectifying circuit 123 to obtain the required power, the other end thereof is coupled to the micro controller 125; the third wireless communication module 124 receives commands from the second wireless communication module 113 and the commands are decoded then output to the micro controller 125.

The micro controller 125 is coupled to the rectifying circuit 123 and the third wireless communication module 124, and operates relative controls, e.g. but not limited to control the ON or OFF status of the switching circuit 126, according to commands of the third wireless communication module 124.

The switching circuit 126 is, e.g. but not limited to, a relay, one end thereof is coupled to the DC power output by the rectifying circuit 123, and the other end thereof is coupled to the micro controller 125 to receive controls from the micro controller 125 so as to be opened or closed, so the DC power is controlled whether output to the electronic device 50.

With the wireless electronic device remote controller provided by the present invention, when a user is several hundred meters away from home, the second wireless communication module 113 of the hand-held wireless communication device 110 can be served to turn on or shut off the power of domestic electronic device 50, therefore each electronic device is equipped with functions of being operated with certain time and magnitude, and environmental benefit of power saving and carbon reducing is achieved. So the wireless electronic device remote controller provided by the present invention is novel compared to a conventional domestic electronic device control system.

As shown in FIG. 6, when the electronic device 50 is an electronic device directly utilizing AC power, e.g. an air conditioner, a television or a lamp, one side of the switching circuit 126 of the present invention is directly coupled to the AC power, the other side thereof is coupled to the micro controller 125, the switching circuit 126 receives controls from the micro controller 125 so as to be opened or closed, so the AC power is controlled whether output to the electronic device 50.

With the wireless electronic device remote controller provided by the present invention, the Zigbee wireless communication module is built-in inside a mobile phone and a power adaptor or distribution box of electronic device, so a user can control the power of electronic device remotely disposed via the mobile phone. So the wireless electronic device remote controller provided by the present invention is novel compared to a conventional domestic electronic device control system.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A wireless electronic device remote controller, comprising:
a hand-held wireless communication device in which at least one display device, a first wireless communication module and a second wireless communication module being installed, wherein the first wireless communication modules being connected to a base station for a communication purpose; and
a power adapter having communication function, coupled to an electronic device and at least having a third wireless communication module receiving commands from the second wireless communication module to determine whether supply power to the electronic device.

2. The wireless electronic device remote controller according to claim 1, wherein the hand-held wireless communication device is a mobile phone.

3. The wireless electronic device remote controller according to claim 1, wherein the first wireless communication module is a GSM, CDMA, W-CDMA, CDMA2000 or CMMB.

4. The wireless electronic device remote controller according to claim 1, wherein the second wireless communication module and the third wireless communication module are a Zigbee communication module, Blue-tooth communication module or RF communication module.

5. The wireless electronic device remote controller according to claim 1, wherein the power adapter having communication function further including:
a transformer, one primary side thereof is coupled to the AC power for lowering the voltage of the AC power;
a rectifying circuit, coupled to a secondary side of the transformer for rectifying the AC power after lowering voltage to a DC power;
a micro controller, coupled to the rectifying circuit and the third wireless communication module, for operating relative controls with respect to commands from the third wireless communication module;
a switching circuit, coupled to the micro controller and able to receive controls from the micro controller to turn on or shut off the power supplying to the electronic device; and
at least one socket, coupled to the switching circuit so the electronic device is able to be plugged therein.

6. The wireless electronic device remote controller according to claim 5, wherein the rectifying circuit is a full-wave rectifying circuit, the switching circuit is a relay.

7. The wireless electronic device remote controller according to claim 1, wherein the electronic device is a computer, an air conditioner, a television or a lamp.

8. A wireless electronic device remote controller, comprising:
a hand-held wireless communication device in which at least one display device, a first wireless communication module and a second wireless communication module being installed, wherein the first wireless communication modules being connected to a base station for a communication purpose; and
a distribution box having communication function having at least one breaker and at least a third wireless communication module, one end of the breaker being coupled to a AC power and the other end thereof being coupled to at least one electronic device, the third wireless communication module receiving commands from the second wireless communication module to control the breaker whether supplies power to the electronic device.

9. The wireless electronic device remote controller according to claim 8, wherein the hand-held wireless communication device is a mobile phone.

10. The wireless electronic device remote controller according to claim 8, wherein the first wireless communication module is a GSM, CDMA, W-CDMA, CDMA2000 or CMMB.

11. The wireless electronic device remote controller according to claim 8, wherein the second wireless communication module and the third wireless communication module are a Zigbee communication module, Blue-tooth communication module or RF communication module.

12. The wireless electronic device remote controller according to claim 8, wherein the distribution box having communication function further including: a transformer, one primary side thereof is coupled to the AC power for lowering the voltage of the AC power;
a rectifying circuit, coupled to a secondary side of the transformer for rectifying the AC power after lowering voltage to a DC power;
a micro controller, coupled to the rectifying circuit and the third wireless communication module, for operating relative controls with respect to commands from the third wireless communication module; and
a switching circuit, coupled to the micro controller and able to receive controls from the micro controller to turn on or shut off the power supplying to the electronic device.

13. The wireless electronic device remote controller according to claim 12, wherein the rectifying circuit is a full-wave rectifying circuit, the switching circuit is a relay.

14. The wireless electronic device remote controller according to claim 8, wherein the electronic device is a computer, an air conditioner, a television or a lamp.
